(19) United States
(12) Patent Application Publication
(10) Pub. No.: US 2025/0063433 A1
(43) Pub. Date: Feb. 20, 2025

(54) METHOD AND APPARATUS FOR ENHANCED PROVISIONING METHODS FOR UPLINK STREAMING IN 5G NETWORKS

(71) Applicant: Tencent America LLC, Palo Alto, CA (US)

(72) Inventor: Iraj SODAGAR, Los Angeles, CA (US)

(73) Assignee: Tencent America LLC, Palo Alto, CA (US)

(21) Appl. No.: 18/799,743

(22) Filed: Aug. 9, 2024

Related U.S. Application Data
(60) Provisional application No. 63/547,522, filed on Nov. 6, 2023.
(60) Provisional application No. 63/547,520, filed on Nov. 6, 2023.
(60) Provisional application No. 63/547,518, filed on Nov. 6, 2023.
(60) Provisional application No. 63/532,865, filed on Aug. 15, 2023.
(60) Provisional application No. 63/532,879, filed on Aug. 15, 2023.

(51) Int. Cl. H04W 28/18; H04L 67/51; H04L 67/55; H04W 64/00

(52) U.S. Cl. CPC H04W 28/18; H04L 67/51; H04L 67/55; H04W 64/003

(57) ABSTRACT

A method includes: provisioning, between a 5th generation media streaming (5GMS) application provider and a 5GMS application function (5GMS AF), a content publishing configuration for uplink streaming in a 5GMS network, where the content publishing configuration comprises a media entry point associated with a 5GMS application server (AS) for uplink streaming, where the content publishing configuration comprises a publishing configuration parameter that specifies one or more protocols for the uplink streaming between a 5GMS client and the 5GMS AS, and where the content publishing configuration comprises a content preparation parameter that indicates a content preparation process performed by the 5GMS AS for egest of the content received from the 5GMS client to the 5GMS application provider.

### CROSS-REFERENCE TO RELATED APPLICATION

This application claims priority from U.S. Provisional Application No. 63/547,522, filed on Nov. 6, 2023 in the United States Patent and Trademark Office, U.S. Provisional Application No. 63/547,520, filed on Nov. 6, 2023 in the United States Patent and Trademark Office, U.S. Provisional Application No. 63/547,518, filed on Nov. 6, 2023 in the United States Patent and Trademark Office, U.S. Provisional Application No. 63/532,865 filed on Aug. 15, 2023 in the United States Patent and Trademark Office, and U.S. Provisional Application No. 63/532,879, filed on Aug. 15, 2023 in the United States Patent and Trademark Office, the disclosures of each of which are incorporated herein by reference in their entirety.

### FIELD

The disclosure generally relates to enhanced provisioning methods for uplink streaming in 5^{th} generation (5G) networks.

### BACKGROUND

The current 5G media streaming architecture defined in 3GPP TS26.501 only defines the general architecture for uplink and downlink media streaming. 3GPP TS26.501 defines the concept of uplink streaming where the content is streamed from the device to an external Service Provider. However, it does not define the provisioning methods for the uplink streaming.

Furthermore, 3GPP TS26.501 defines the concept of uplink streaming where the content is streamed from the device to an external Service Provider. It also defines the background data transfer for downlink streaming. However, it does not define the call flow for the uplink background data transfer.

While 3GPP TS26.501, defines the concept of uplink streaming where the content is streamed from the device to an external Service Provider, and defines the dynamic policies invocation for download streaming, 3GPP TS26.501 lacks these feature for uplink streaming.

3GPP has defined a work item on split rendering of media delivery services, in which the client media functions are split between the device and the network edge. Therefore the client runs lighter less demanding processes and can receive more complicated applications and services. In turn, the edge network would receive the media, decode and partially render it to a simpler form, so that the client can run a lighter process.

### SUMMARY

According to an aspect of a disclosure, a method performed by at least one processor includes: provisioning, between a 5^{th} generation media streaming (5GMS) application provider and a 5GMS application function (5GMS AF), a content publishing configuration for uplink streaming in a 5GMS network, in which the content publishing configuration comprises a media entry point associated with a 5GMS application server (AS) for uplink streaming, in which the content publishing configuration comprises a publishing configuration parameter that specifies one or more protocols for the uplink streaming between a 5GMS client and the 5GMS AS, and in which the content publishing configuration comprises a content preparation parameter that indicates a content preparation process performed by the 5GMS AS for egest of the content received from the 5GMS client to the 5GMS application provider.

According to an aspect of the disclosure, a method performed by at least one processor includes: provisioning, by a 5^{th} generation media streaming (5GMS) a policy template associated with a background data transfer policy for uplink streaming in a 5GMS network, in which the background data transfer policy comprises a background data transfer window, and in which the background data transfer policy is provided to a user equipment.

According to an aspect of the disclosure, a method performed by at least one processor includes provisioning a split-rendering configuration in a 5^{th} generation (5G) network that specifies position information for one or more user equipment (UEs) to report to the network, in which the position parameters specify at least a frequency for reporting and an interval for reporting the position information, and in which the position parameters are reported to the one or more UEs as part of the split-rendering configuration.

### BRIEF DESCRIPTION OF THE DRAWINGS

Further features, the nature, and various advantages of the disclosed subject matter will be more apparent from the following detailed description and the accompanying drawings in which:

FIG. 1 is a diagram of an environment in which methods, apparatuses, and systems described herein may be implemented, according to embodiments.

FIG. 2 is a block diagram of example components of one or more devices of FIG. 1.

FIG. 3 is a diagram of a media architecture for media uplink and downlink streaming, according to embodiments.

FIG. 4 is a diagram of a media architecture for media streaming, according to embodiments.

FIGS. 5 and 6 illustrate a flow diagram of configuration and usage of a Background Data Transfer session in uplink 5G Media Streaming.

FIG. 7 illustrates a flow diagram of establishing uplink streaming using dynamic policies on network slices.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure may be practiced without one or more of the specific features or advantages of a particular embodiment. In other instances, additional features and advantages may be recognized in certain embodiments that may not be present in all embodiments of the present disclosure.

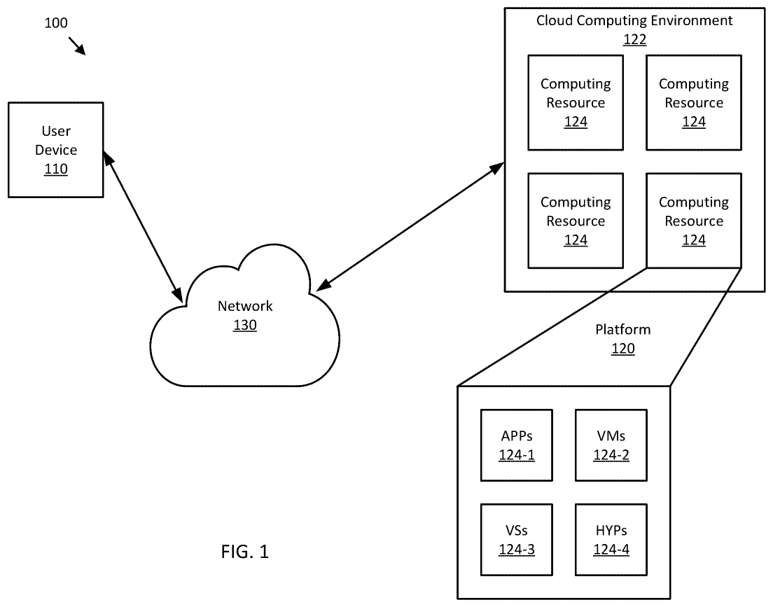

FIG. 1 is a diagram of an environment 100 in which methods, apparatuses, and systems described herein may be implemented, according to embodiments. As shown in FIG. 1, the environment 100 may include a user device 110, a platform 120, and a network 130. Devices of the environment 100 may interconnect via wired connections, wireless connections, or a combination of wired and wireless connections.

The user device 110 includes one or more devices capable of receiving, generating, storing, processing, and/or providing information associated with platform 120. For example, the user device 110 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, the user device 110 may receive information from and/or transmit information to the platform 120.

The platform 120 includes one or more devices as described elsewhere herein. In some implementations, the platform 120 may include a cloud server or a group of cloud servers. In some implementations, the platform 120 may be designed to be modular such that software components may be swapped in or out depending on a particular need. As such, the platform 120 may be easily and/or quickly reconfigured for different uses.

In some implementations, as shown, the platform 120 may be hosted in a cloud computing environment 122. Notably, while implementations described herein describe the platform 120 as being hosted in the cloud computing environment 122, in some implementations, the platform 120 may not be cloud-based (i.e., may be implemented outside of a cloud computing environment) or may be partially cloud-based.

The cloud computing environment 122 includes an environment that hosts the platform 120. The cloud computing environment 122 may provide computation, software, data access, storage, etc. services that do not require end-user (e.g. the user device 110) knowledge of a physical location and configuration of system(s) and/or device(s) that hosts the platform 120. As shown, the cloud computing environment 122 may include a group of computing resources 124 (referred to collectively as “computing resources 124” and individually as “computing resource 124”).

The computing resource 124 includes one or more personal computers, workstation computers, server devices, or other types of computation and/or communication devices. In some implementations, the computing resource 124 may host the platform 120. The cloud resources may include compute instances executing in the computing resource 124, storage devices provided in the computing resource 124, data transfer devices provided by the computing resource 124, etc. In some implementations, the computing resource 124 may communicate with other computing resources 124 via wired connections, wireless connections, or a combination of wired and wireless connections.

As further shown in FIG. 1, the computing resource 124 includes a group of cloud resources, such as one or more applications (APPs) 124-1, one or more virtual machines (VMs) 124-2, virtualized storage (VSs) 124-3, one or more hypervisors (HYPs) 124-4, or the like.

The application 124-1 includes one or more software applications that may be provided to or accessed by the user device 110 and/or the platform 120. The application 124-1 may eliminate a need to install and execute the software applications on the user device 110. For example, the application 124-1 may include software associated with the platform 120 and/or any other software capable of being provided via the cloud computing environment 122. In some implementations, one application 124-1 may send/receive information to/from one or more other applications 124-1, via the virtual machine 124-2.

The virtual machine 124-2 includes a software implementation of a machine (e.g. a computer) that executes programs like a physical machine. The virtual machine 124-2 may be either a system virtual machine or a process virtual machine, depending upon use and degree of correspondence to any real machine by the virtual machine 124-2. A system virtual machine may provide a complete system platform that supports execution of a complete operating system (OS). A process virtual machine may execute a single program, and may support a single process. In some implementations, the virtual machine 124-2 may execute on behalf of a user (e.g. the user device 110), and may manage infrastructure of the cloud computing environment 122, such as data management, synchronization, or long-duration data transfers.

The virtualized storage 124-3 includes one or more storage systems and/or one or more devices that use virtualization techniques within the storage systems or devices of the computing resource 124. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

The hypervisor 124-4 may provide hardware virtualization techniques that allow multiple operating systems (e.g. “guest operating systems”) to execute concurrently on a host computer, such as the computing resource 124. The hypervisor 124-4 may present a virtual operating platform to the guest operating systems, and may manage the execution of the guest operating systems. Multiple instances of a variety of operating systems may share virtualized hardware resources.

The network 130 includes one or more wired and/or wireless networks. For example, the network 130 may include a cellular network (e.g. a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g. the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g. one or more devices) of the environment 100 may perform one or more functions described as being performed by another set of devices of the environment 100.

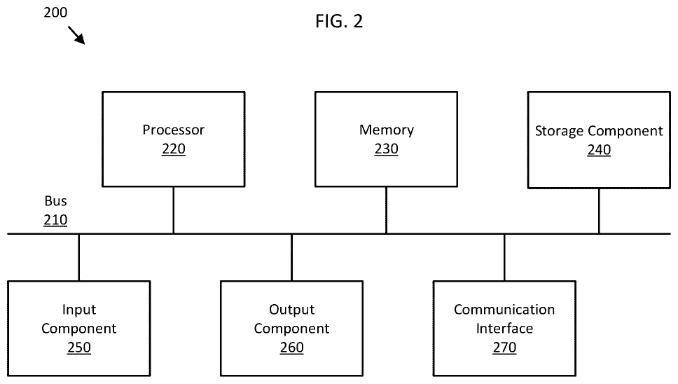

FIG. 2 is a block diagram of example components of one or more devices of FIG. 1. The device 200 may correspond to the user device 110 and/or the platform 120. As shown in FIG. 2, the device 200 may include a bus 210, a processor 220, a memory 230, a storage component 240, an input component 250, an output component 260, and a communication interface 270.

The bus 210 includes a component that permits communication among the components of the device 200. The processor 220 is implemented in hardware, firmware, or a combination of hardware and software. The processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, the processor 220 includes one or more processors capable of being programmed to perform a function. The memory 230 includes a random access memory (RAM), a read only memory (ROM), and/or another type of dynamic or static storage device (e.g. a flash memory, a magnetic memory, and/or an optical memory) that stores information and/or instructions for use by the processor 220.

The storage component 240 stores information and/or software related to the operation and use of the device 200. For example, the storage component 240 may include a hard disk (e.g. a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 250 includes a component that permits the device 200 to receive information, such as via user input (e.g. a touch screen display, a keyboard, a keypad, a mouse, a button, a switch, and/or a microphone). Additionally, or alternatively, the input component 250 may include a sensor for sensing information (e.g. a global positioning system (GPS) component, an accelerometer, a gyroscope, and/or an actuator). The output component 260 includes a component that provides output information from the device 200 (e.g. a display, a speaker, and/or one or more light-emitting diodes (LEDs)).

The communication interface 270 includes a transceiver-like component (e.g., a transceiver and/or a separate receiver and transmitter) that enables the device 200 to communicate with other devices, such as via a wired connection, a wireless connection, or a combination of wired and wireless connections. The communication interface 270 may permit the device 200 to receive information from another device and/or provide information to another device. For example, the communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

The device 200 may perform one or more processes described herein. The device 200 may perform these processes in response to the processor 220 executing software instructions stored by a non-transitory computer-readable medium, such as the memory 230 and/or the storage component 240. A computer-readable medium is defined herein as a non-transitory memory device. A memory device includes memory space within a single physical storage device or memory space spread across multiple physical storage devices.

Software instructions may be read into the memory 230 and/or the storage component 240 from another computer-readable medium or from another device via the communication interface 270. When executed, software instructions stored in the memory 230 and/or the storage component 240 may cause the processor 220 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, the device 200 may include additional components, fewer components, different components, or differently arranged components than those shown in FIG. 2. Additionally, or alternatively, a set of components (e.g. one or more components) of the device 200 may perform one or more functions described as being performed by another set of components of the device 200.

A 5G media streaming (5GMS) system may be an assembly of application functions, application servers, and interfaces from the 5G media streaming architecture that support either downlink media streaming services or uplink media streaming services, or both. A 5GMS Application Provider may include a party that interacts with functions of the 5GMS system and supplies a 5GMS Aware Application that interacts with functions of the 5GMS system. The 5GMS Aware Application may refer to an application in the user equipment (UE), provided by the 5GMS Application Provider, that contains the service logic of the 5GMS application service, and interacts with other 5GMS Client and Network functions via the interfaces and application programming interfaces (APIs) defined in the 5GMS architecture. A 5GMS Client may refer to a UE function that is either a 5GMS downlink (5GMSd) Client or a 5GMS uplink (5GMSu) Client, or both.

The 5GMSd Client may refer to a UE function that includes at least a 5G media streaming player and a media session handler for downlink streaming and that may be accessed through well-defined interfaces/APIs. The 5GMSu Client may refer to an originator of a 5GMSu service that may be accessed through well-defined interfaces/APIs. A 5GMSu media streamer may refer to a UE function that enables uplink delivery of streaming media content to an Application Server (AS) function of the 5GMS Application Provider, and which interacts with both the 5GMSu Aware Application for media capture and subsequent streaming, and the Media Session Handler for media session control.

A dynamic policy may refer to a dynamic policy and charging control (PCC) rule for an uplink or downlink application flow during a media session. An egest session may refer to an uplink media streaming session from the 5GMS AS towards the 5GMSu Application Provider. An ingest session may refer to a session to upload the media content to a 5GMSd AS. A policy template may refer to a collection of (semi-static) Policy or Control Function (PCF)/Network Exposure Function (NEF) API parameters which are specific to the 5GMS Application Provider and also the resulting PCC rule. A policy template ID may identify the desired policy template, which is used by the 5GMSd Application Function (AF) to select the appropriate PCF/NEF API towards the 5G system so that the PCF can compile the desired PCC rule. The Media Player Entry may refer to a document or a pointer to a document that defines a media presentation (e.g., a media presentation description (MPD) for DASH or a uniform resource locator (URL) to a video clip file). A Media Streamer Entry may refer to a pointer (e.g., in the form of a URL) that defines an entry point of an uplink media streaming session. A presentation entry may refer to a document or a pointer to a document that defines an application presentation, such as an HTML5 document.

A Provisioning Session may refer to a data structure supplied at an interface (Mld) by a 5GMSd Application provider that configures the 5GMSd features relevant to a set of 5GMSd Aware Applications. A 5GMSd Media Player may refer to a UE function that enables playback and rendering of a media presentation based on a media play entry and exposing some basic controls such as play, pause, seek, and stop, to the 5GMSd Aware Application. Server Access Information may refer to a set of parameters and addresses (including 5GMSd AF and 5GMSd AS addresses) which are needed to activate the reception of a streaming session. A Service and Content Discovery may refer to functionality and procedures provided by a 5GMSd Application Provider to a 5GMS Aware Application that enables the end user to discover the available streaming service and content offerings and select a specific service or content item for access. A Service Announcement may refer to procedures conducted between the 5GMS Aware Application and the 5GMS Application Provider such that the 5GMS Aware Application is able to obtain 5GMS Service Access Information, either directly or in the form of a reference to that information.

A third party player may refer to a part of an application that uses APIs to exercise selected 5GMSd functions to play back media content. A third party uplink streamer may refer to a part of an application that uses APIs to exercise selected 5GMSu functions to capture and stream media content.

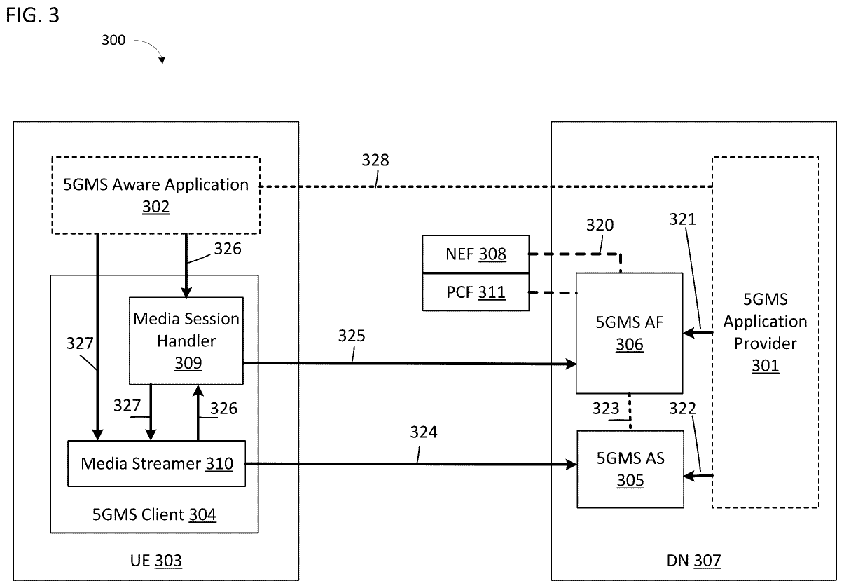

FIG. 3 is a diagram of a media architecture 300 for media streaming according to embodiments. A 5GMS Application Provider 301 may use 5GMS for uplink streaming services. In one or more examples, a streaming service may be a live video streaming session using a social medial platform. The 5GMS Application Provider 301 may be implemented as a server. The 5GMS Application Provider 301 may provide a 5GMS Aware Application 302 on a UE 303 to make use of 5GMS Client 304 and network functions using interfaces and APIs defined in 5GMS. A 5GMS application server (AS) 305 may be an AS dedicated to 5G Media Uplink Streaming. The 5GMS Client 304 may be an internal function of the UE 303 dedicated to 5G Media Streaming.

A 5GMS application function (AF) 306 and the 5GMS AS 305 may be Data Network (DN) 307 functions. The 5GMS AF 306 may be implemented as a server. Functions in trusted DNs may be trusted by the operator's network. Therefore, AFs in trusted DNs may directly communicate with some or all 5G Core functions. Functions in external DNs may only communicate with 5G Core functions via a network exposure function (NEF) 308 using link 320. The NEF 308 facilitates secure access to exposed network services and capabilities of the 5G network.

The media architecture 300 may connect UE 303 internal functions and related network functions for 5G Media Streaming. Accordingly, the media architecture 300 may include a number of functions. For example, the 5GMS Client 304 on UE 303 may be an originator of a 5GMS service that may be accessed through interfaces/APIs. The 5GMS Client 304 may include two sub-functions, a Media Session Handler 309 and a Media Streamer 310. The Media Session Handler 309 may communicate with the 5GMS AF 306 in order to establish, control and support the delivery of a media session. The Media Session Handler 309 may expose APIs that may be used by the 5GMS Aware Application 302. The Media Streamer 310 may communicate with 5GMS AS 305 to stream the media content and provide a service to the 5GMS Aware Application 302 for media capturing and streaming, and the Media Session Handler 309 for media session control. The 5GMS Aware Application 302 may control the 5GMS Client 304 by implementing external application or content service provider specific logic and enabling the establishment of a media session. The 5GMS AS 305 may host 5G media functions and may be implemented as a content delivery network (CDN), for example. The 5GMS Application Provider 301 may be an external application or content specific media functionality (e.g., media storage, consumption, transcoding and redistribution) that uses 5GMS to stream media from the 5GMS Aware Application 302. The 5GMS AF 306 may provide various control functions to the Media Session Handler 309 on the UE 303 and/or to the 5GMS Application Provider 301. The 5GMS AF 306 may relay or initiate a request for a different policy control function (PCF) 311 treatment or interact with other network functions.

The media architecture 300 may include a number of different interfaces. For example, link 321 may relate to M1, which may be a 5GMS Provisioning API exposed by 5GMS AF 306 to provision usage of media architecture 300 and to obtain feedback. Link 322 may relate to M2, which may be a 5GMS Publish API exposed by 5GMS AS 305 and used when the 5GMS AS 305 in a trusted DN, such as DN 307, is selected to receive content for streaming service. Link 323 may relate to M3, which may be an internal API used to exchange information for content hosting on 5GMS AS 305 within a trusted DN such as DN 307. Link 324 may relate to M4, which may be a Media Streaming API exposed by the 5GMS AS 305 to the Media Streamer 310 to stream media content. Link 325 may relate to M5, which may be a Media Session Handling API exposed by 5GMS AF 305 to Media Session Handler for media session handling, control, and assistance that also include appropriate security mechanisms (e.g., authorization and authentication). Link 326 may relate to M6, which may be a UE 303 Media Session Handling API exposed by Media Session Handler 309 to 5GMS Aware Application 302 to make use of 5GMS functions. Link 327 may relate to M7, which may be a UE Media Streamer API exposed by Media Streamer 310 to the 5GMS Aware Application 302 and the Media Session Handler 309 to make use of the Media Streamer 310. Link 328 may relate to M8, which may be an Application API which is used for information exchange between 5GMS Aware Application 302 and 5GMS Application Provider 301, for example to provide service access information to the 5GMS Aware Application 302. The UE 303 may also be implemented in a self-contained manner such that interfaces M6 326 and M7 327 are not exposed.

The architecture illustrated in FIG. 3 defines how a client can use a streaming format to stream the content from the 5GMS Application provider through the 5GMS architecture. This architecture provides the entry point for that format through the service access information provided either through M8 or M5. The entry point is either a document or a pointer to a document that defines the streaming format. Recently, 3GPP considered adding multiple entry points for the same service using one or more formats. In this case, the service operation information includes the information regarding these entry points. The client chooses a format and uses the corresponding entry point to start streaming the content.

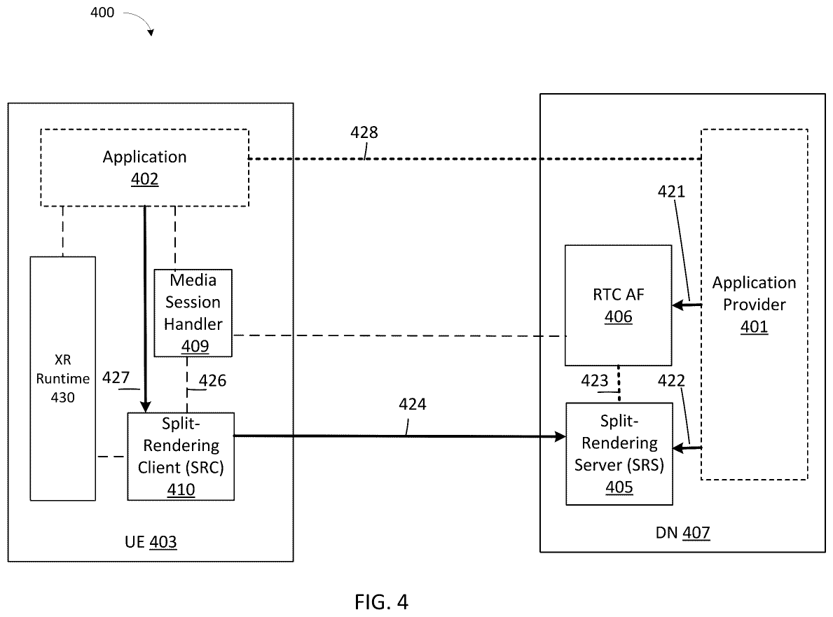

FIG. 4 is a diagram of a media architecture 400 for media uplink streaming according to embodiments. A 5GMS Application Provider 401 may use 5GMS for streaming services. In one or more examples, a streaming service may be a live video streaming session using a social medial platform. The 5GMS Application Provider 401 may be implemented as a server. The 5GMS Application Provider 401 may provide a 5GMS Aware Application 402 on a UE 403 to make use of 5GMS Client 404 and network functions using interfaces and APIs defined in 5GMS. A 5GMS application server (AS) 405 may be an AS dedicated to 5G Media Streaming. The 5GMS Client 404 may be an internal function of the UE 403 dedicated to 5G Media Streaming.

A 5GMS application function (AF) 406 and the 5GMS AS 405 may be Data Network (DN) 407 functions. The 5GMS AF 406 may be implemented as a server. Functions in trusted DNs may be trusted by the operator's network. Therefore, AFs in trusted DNs may directly communicate with some or all 5G Core functions. Functions in external DNs may only communicate with 5G Core functions via a network exposure function (NEF) 408 using link 420. The NEF 408 facilitates secure access to exposed network services and capabilities of the 5G network.

The media architecture 400 may connect UE 403 internal functions and related network functions for 5G Media Streaming. Accordingly, the media architecture 400 may include a number of functions. For example, the 5GMS Client 404 on UE 403 may be an originator of a 5GMS service that may be accessed through interfaces/APIs. The 5GMS Client 404 may include two sub-functions, a Media Session Handler 409 and a Media Stream Handler 410. The Media Session Handler 409 may communicate with the 5GMS AF 406 in order to establish, control and support the delivery of a media session. The Media Session Handler 409 may expose APIs that may be used by the 5GMS Aware Application 402. The Media Streamer 410 may communicate with 5GMS AS 405 to stream the media content and provide a service to the 5GMS Aware Application 402 for media capturing and streaming, and the Media Session Handler 409 for media session control. The 5GMS Aware Application 402 may control the 5GMS Client 404 by implementing external application or content service provider specific logic and enabling the establishment of a media session. The 5GMS AS 405 may host 5G media functions and may be implemented as a content delivery network (CDN), for example. The 5GMS Application Provider 401 may be an external application or content specific media functionality (e.g., media storage, consumption, transcoding and redistribution) that uses 5GMS to stream media from the 5GMSu Aware Application 402. The 5GMS AF 406 may provide various control functions to the Media Session Handler 409 on the UE 403 and/or to the 5GMSu Application Provider 401. The 5GMSu AF 406 may relay or initiate a request for a different policy control function (PCF) 411 treatment or interact with other network functions.

The media architecture 400 may include a number of different interfaces. For example, link 421 may relate to M1, which may be a 5GMS Provisioning API exposed by 5GMS AF 406 to provision usage of media architecture 400 and to obtain feedback. Link 422 may relate to M2, which may be a 5GMS Publish API exposed by 5GMS AS 405 and used when the 5GMS AS 405 in a trusted DN, such as DN 407, is selected to receive content for streaming service. Link 423 may relate to M3, which may be an internal API used to exchange information for content hosting on 5GMS AS 405 within a trusted DN such as DN 407. Link 424 may relate to M4, which may be a Media Streaming API exposed by the 5GMS AS 405 to the Media Streamer 410 to stream media content. Link 425 may relate to M5, which may be a Media Session Handling API exposed by 5GMS AF 405 to Media Session Handler for media session handling, control, and assistance that also include appropriate security mechanisms (e.g., authorization and authentication). Link 426 may relate to M6, which may be a UE 403 Media Session Handling API exposed by Media Session Handler 409 to 5GMS Aware Application 402 to make use of 5GMS functions. Link 427 may relate to M7, which may be a UE Media Streamer API exposed by Media Streamer 410 to the 5GMS Aware Application 402 and the Media Session Handler 409 to make use of the Media Streamer 410. Link 428 may relate to M8, which may be an Application API which is used for information exchange between 5GMS Aware Application 402 and 5GMS Application Provider 401, for example to provide service access information to the 5GMS Aware Application 402. The UE 403 may also be implemented in a self-contained manner such that interfaces M6 426 and M7 427 are not exposed.

While 3GPP TS 26.501 defines the general uplink process, it does not define a provisioning process for the uplink streaming. While 3GPP TS 26.512 defines the general uplink process, it does not define a set of provision method for content publishing of the uplink streaming.

Embodiments of the present disclosure are directed to enhanced provisioning methods for uplink streamlining. These procedures may be used by the 5GMSu Application Provider 301 and the 5GMSu AF at reference point M1u to provision the content publishing feature for uplink media streaming.

The embodiments include a create content publishing configuration. This procedure may be used by the 5GMSu Application Provider 301 to create a new Content Publishing Configuration. The 5GMSu Application Provider 301 may use the HTTP POST method for this purpose and the request message body shall include a ContentPublishingConfiguration resource.

In one or more examples, if the Content Publishing Configuration uses the Push-based content ingest method, e.g., the pull attribute is set to False, then the publishingConfiguration.baseURL property shall be nominated by the 5GMSu Application Provider in the request message body. The 5GMSu AF 306 shall not change the value of publishingConfiguration.baseURL property in its response.

In one or more examples, if the Content Hosting Configuration uses the Pull-based content ingest st method, i.e. the pull attribute is set to True, then the publishingConfiguration.baseURL property shall be nominated by the 5GMSu AF 306 and returned in the response message body. It shall not be set by the 5GMSu Application Provider 301 in the request message body. If the procedure is successful, the 5GMSu AF 306 shall generate a resource identifier representing the new Content Publishing Configuration. In this case, the 5GMSu AF 306 shall respond with a 201 (Created) HTTP response message and shall provide the URL to the newly created resource in the Location header field. The response message body may include a ContentPublishingConfiguration resource that represents the current state of the Content Publishing Configuration, including any fields set by the 5GMSu AF.

If the procedure is not successful, the 5GMSu AF shall provide an error response code.

The embodiments include a Retrieve Content Publishing Configuration. This procedure may be used by the 5GMSu Application Provider 301 to obtain the properties of an existing Content Publishing Configuration resource from the 5GMSu AF. The HTTP GET method may be used for this purpose.

If the procedure is successful, the 5GMSu AF 306 may respond with a 200 (OK) response message that includes the ContentPublishingConfiguration resource in the response message body.

If the procedure is not successful, the 5GMSu AF 306 may provide an error response code.

Embodiments include an Update Content Publishing Configuration. The update operation may be invoked by the 5GMSuApplication Provider 301 to modify the properties of an existing ContenPublishingConfiguration resource. All writeable properties may be updated. The HTTP PATCH or HTTP PUT methods may be used for the update operation. If the procedure is successful, the 5GMSu AF shall respond with a 200 (OK) and provide the content of the resource in the response, confirming the successful update operation.

If the procedure is not successful, the 5GMSu AF 306 may provide an error response code.

Embodiments include a Destroy Content Publishing Configuration. This operation may be used by the 5GMSu Application Provider 301 to destroy a Content Publishing Configuration resource and to terminate the related distribution. The HTTP DELETE method shall be used for this purpose. As a result, the 5GMSu AF 306 may release any associated network resources, purge any cached content, and delete any corresponding configurations.

If the procedure is successful, the 5GMSu AF may respond with a 200 (OK) response message.

Embodiments include a Purge Content Publishing Cache. This operation may be used by the 5GMSu Application Provider 301 to purge content in a Content Publishing cache. The HTTP POST method shall be used for this purpose with the expression describing the media resource URLs to be purged in the body of the request. As a result, the 5GMSu AF will purge the corresponding cached content.

If the procedure is successful, the 5GMSu AF 306 may respond with a 200 (OK) response message. If the procedure is not successful, the 5GMSu AF 306 may provide an error response code.

Embodiments include a Content Publishing Provisioning API. This clause may specify the API that the 5GMSu Application Provider 301 uses at reference point M1u to provision and manages 5GMSu AS 305 Content Publishing Configurations by interacting with a 5GMSu AF 306. Each such configuration is represented by a ContentPublishingConfiguration, the data model for which is specified below. The RESTful resources for managing Content Publishing Configurations may be specified.

In one or more examples, the Content Publishing Provisioning API may be accessible through this URL base path:
{apiRoot}/3gpp-ml/{apiVersion}/provisioning-sessions/{provisioningSessionId}/

Table 1 below specifies the operations and the corresponding HTTP methods that are supported by this API, according to one or more embodiments. In each case, the Provisioning Session identifier may be substituted into {provisioningSessionId} in the above URL template and the sub-resource path specified in the second column shall be appended to the URL base path.

TABLE 1

| | | Allowed | |
|---|---|---|---|
| | | HTTP | |
| Operation | Sub-resource path | method(s) | Description |
| Create Content | content-publishing- | POST | Used to create a Content |
| Publishing | configuration | | Publishing Configuration resource. |
| Configuration | | | |
| Retrieve Content | | GET | Used to retrieve an existing |
| Publishing | | | Content Publishing Configuration. |
| Configuration | | | |
| Update Content | | PUT, | Used to modify an existing |
| Publishing | | PATCH | Content Publishing Configuration. |
| Configuration | | | |
| Delete Content | | DELETE | Used to delete an existing Content |
| Publishing | | | Publishing Configuration. |
| Configuration | | | |

Embodiments include a ContentPublishingConfiguration resource. An example data model for the ContentPublishingConfiguration resource is specified in Table 2 below.

TABLE 2

| Property name | Data type | Cardinality | Description |
|---|---|---|---|
| Name | string | 1 . . . 1 | A name for this Content Publishing |
| | | | Configuration. |
| contributionConfigurations | Array(object) | 1 . . . N | Each contribution configuration specifies |
| | | | a Media Entry Point and any content |
| | | | preparation required for the egested |
| | | | content. |
| entryPoint | M1MediaEntry | 1 . . . 1 | A Media Entry Point generated by the |
| | Point | | 5GMS System, and used by the Media |
| | | | Streamer to initiate a media streaming |
| | | | session at reference point M4u |
| | | | contributing content to the 5GMSu AS. |
| | | | The semantics of the entry point are |
| | | | dependent on the contentType. |
| relativePath | RelativeURL | 1 . . . 1 | A relative path (i.e., without a scheme or |
| | | | any leading forward slash characters) to |
| | | | the resource for the Media Entry Point. |
| contentType | string | 1 . . . 1 | The MIME content type of this Media |
| | | | Entry Point. |
| | | | Used by the 5GMS Client to select a |
| | | | contribution configuration. |
| Profiles | Array(Uri) | 0 . . . 1 | An optional list of conformance profile |
| | | | identifiers associated with this Media |
| | | | Entry Point, each one expressed as a URI. |
| | | | A profile URI may indicate an |
| | | | interoperability point, for example. |
| | | | Used by the 5GMS Client to select a |
| | | | contribution configuration. |
| | | | If present, the array shall contain at least |
| | | | one item. |
| content | ResourceId | 0 . . . 1 | Indicates that content preparation prior to |
| Preparation | | | egest is requested by the 5GMSu |
| TemplateId | | | Application Provider to transform |
| | | | contributed content into the required egest |
| | | | format. This property identifies the |
| | | | Content Preparation Template that shall be |
| | | | used for this transformation. |
| canonical | string | 1 . . . 1 | The Fully Qualified Domain Name of the |
| DomainName | | | 5GMSu AS assigned by the 5GMSu AF |
| | | | through which resources are contributed by |
| | | | default. |
| domainNameAlias | string | | The 5GMSu Application Provider may |
| | | | assign another Fully-Qualified Domain |
| | | | Name through which media resources may |
| | | | additionally be contributed at reference |
| | | | point M4u. |
| | | | This domain name is used by the |
| | | | 5GMSu AS to select an appropriate Server |
| | | | Certificate to present at M4u, and to set |
| | | | appropriate CORS HTTP response headers |
| | | | at M4u. |
| | | | If this property is present, the 5GMSu |
| | | | Application Provider is responsible for |
| | | | providing in the DNS a CNAME record |
| | | | that resolves domainNameAlias to |
| | | | canonicalDomainName. |
| certificateId | string | 0 . . . 1 | When content is contributed using TLS, |
| | | | the X.509 certificate to be presented by the |
| | | | 5GMSu AS in the TLS handshake at M4u |
| | | | is shared with the 5GMSd AF. This |
| | | | property indicates the identifier of the |
| | | | certificate to use. |
| publishingConfiguration | object | 1 . . . 1 | Describes the 5GMSu Application |
| | | | Provider's origin server to which media |
| | | | resources will be egested via interface |
| | | | M2u. |
| Pull | boolean | 1 . . . 1 | Indicates whether pull- or push- based |
| | | | content egest is to be used for egesting |
| | | | content from the 5GMSu AS to the |
| | | | 5GMSu Application Provider. |
| protocol | Uri | 1 . . . 1 | A fully-qualified term identifier allocated |
| | | | in the name space urn:3gpp:5gms:content- |
| | | | protocol that identifies the content egest |
| | | | protocol. |
| base URL | Absolute URL | 1 . . . 1 | A base URL (i.e., one that includes a |
| | | | scheme, authority and, optionally, path |
| | | | segments) to which content is published at |
| | | | reference point M2d for this publishing |
| | | | configuration. |
| | | | In the case of pull-based content egest |
| | | | (pull flag is set to True), this property is |
| | | | populated by the 5GMSd AF to indicate |
| | | | the location on the 5GMSu AS from which |
| | | | content is to be pulled for this Content |
| | | | Publishing Configuration. An uplink media |
| | | | streaming request received at reference |
| | | | point M4u is mapped by the 5GMSu AS to |
| | | | a URL at reference point M2u whose base |
| | | | is the value of this property. |
| | | | In the case of push-based content egest |
| | | | (pull flag is set to False), this property is |
| | | | nominated by the 5GMSu Application |
| | | | Provider and indicates the base URL to |
| | | | which content for this Content Hosting |
| | | | Configuration is to be published. |

The embodiments include an Operations clause. This clause may define the behavior that is expected from the 5GMSu AS 305 when the Content Publishing Configuration has been successfully provisioned. The 5GMSu client 304 chooses one uplink streaming protocol based on provided information in one or more Content Publishing Configurations. The corresponding Content Publishing Configuration also provides if the 5GMSu AS is required to perform content preparation process, the caching requirements, and the egest protocol for the uplinked content to be delivered to the 5GMSu Application Provider.

In one or more examples, the 5GMSd AS 305 can perform various content processing tasks (such as repackaging, encryption, ABR transcoding) on media resources prior to serving them at M2u. These processing tasks may be specified in a Content Preparation Template resource referenced from the Content Publishing Configuration object.

According to one or more embodiments, a method for provisioning uplink streaming in 5G networks using the 5G media streaming architecture wherein the provisioning of the content publishing service including setting up the application servers, content preparation process, use of one or more protocols for uplink and egest, dynamic policies and edge computing resources wherein the 5G Application service provider request provisioning of a content publishing service wherein one or more protocols for uplink streaming is defined and the 5G client can pick one of them for uplink streaming, where the content is egested through one or more paths that is defined using pull or push method for each one, where the Application Service can retrieve, update or delete the content publishing services by accessing the content publishing configuration resource.

While 3GPP TS 26.501 and 3GPP TS 26.512 define the general uplink process, it does not define any caching operation for uplink streaming.

Embodiments are directed to defining a caching operation for uplink streaming. The embodiments add a cache to the 5GMSu AS 305 to be able to cache the uplink streamed media content for consumption by the 5GMS Application AS 305. The 5GMSu client 304 chooses one uplink streaming protocol based on provided information in one or more Content Publishing Configurations. The corresponding Content Publishing Configuration also provides if the 5GMSu AS is required to cache the content for the egest by the 5GMSu Application Provider.

According to one or more embodiments, content caching is included in the ContentPublishingConfiguration resource. An example of the added information to the ContentPublishingConfiguration resource for content caching is shown in Table 3 below.

TABLE 3

| Property name | Data type | Cardinality | Description |
|---|---|---|---|
| Name | string | 1 . . . 1 | A name for this Content Publishing |
| | | | Configuration. |
| contribution Configurations | Array(object) | 1 . . . N | Each contribution configuration specifies a |
| | | | Media Entry Point and any content |
| | | | preparation required for the egested |
| | | | content. |
| entryPoint | M1MediaEntry | 1 . . . 1 | A Media Entry Point generated by the |
| | Point | | 5GMS System, and used by the Media |
| | | | Streamer to initiate a media streaming |
| | | | session at reference point M4u |
| | | | contributing content to the 5GMSu AS. |
| | | | The semantics of the entry point are |
| | | | dependent on the contentType. |
| relativePath | RelativeURL | 1 . . . 1 | A relative path (i.e., without a scheme or |
| | | | any leading forward slash characters) to |
| | | | the resource for the Media Entry Point. |
| contentType | string | 1 . . . 1 | The MIME content type of this Media |
| | | | Entry Point. |
| | | | Used by the 5GMS Client to select a |
| | | | contribution configuration. |
| profiles | Array(Uri) | 0 . . . 1 | An optional list of conformance profile |
| | | | identifiers associated with this Media |
| | | | Entry Point, each one expressed as a URI. |
| | | | A profile URI may indicate an |
| | | | interoperability point, for example. |
| | | | Used by the 5GMS Client to select a |
| | | | contribution configuration. |
| | | | If present, the array shall contain at least |
| | | | one item. |
| content | ResourceId | 0 . . . 1 | Indicates that content preparation prior to |
| Preparation | | | egest is requested by the 5GMSu |
| TemplateId | | | Application Provider to transform |
| | | | contributed content into the required egest |
| | | | format. This property identifies the |
| | | | Content Preparation Template that shall be |
| | | | used for this transformation. |
| canonical | string | 1 . . . 1 | The Fully Qualified Domain Name of the |
| DomainName | | | 5GMSu AS assigned by the 5GMSu AF |
| | | | through which resources are contributed by |
| | | | default. |
| domainNameAlias | string | | The 5GMSu Application Provider may |
| | | | assign another Fully-Qualified Domain |
| | | | Name through which media resources may |
| | | | additionally be contributed at reference |
| | | | point M4u. |
| | | | This domain name is used by the |
| | | | 5GMSu AS to select an appropriate Server |
| | | | Certificate to present at M4u and to set |
| | | | appropriate CORS HTTP response headers |
| | | | at M4u. |
| | | | If this property is present, the 5GMSu |
| | | | Application Provider is responsible for |
| | | | providing in the DNS a CNAME record |
| | | | that resolves domainNameAlias to |
| | | | canonicalDomainName. |
| certificateId | string | 0 . . . 1 | When content is contributed using TLS, |
| | | | the X.509 certificate to be presented by the |
| | | | 5GMSu AS in the TLS handshake at M4u |
| | | | is shared with the 5GMSd AF. This |
| | | | property indicates the identifier of the |
| | | | certificate to use. |
| publishingConfiguration | object | 1 . . . 1 | Describes the 5GMSu Application |
| | | | Provider's origin server to which media |
| | | | resources will be egested via interface |
| | | | M2u. |
| pull | boolean | 1 . . . 1 | Indicates whether pull- or push- based |
| | | | content egest is to be used for egesting |
| | | | content from the 5GMSu AS to the |
| | | | 5GMSu Application Provider. |
| protocol | Uri | 1 . . . 1 | A fully-qualified term identifier allocated |
| | | | in the name space urn:3gpp:5gms:content- |
| | | | protocol that identifies the content egest |
| | | | protocol. |
| baseURL | AbsoluteURL | 1 . . . 1 | A base URL (i.e., one that includes a |
| | | | scheme, authority and, optionally, path |
| | | | segments) to which content is published at |
| | | | reference point M2d for this publishing |
| | | | configuration. |
| | | | In the case of pull-based content egest |
| | | | (pull flag is set to True), this property is |
| | | | populated by the 5GMSd AF to indicate |
| | | | the location on the 5GMSu AS from which |
| | | | content is to be pulled for this Content |
| | | | Publishing Configuration. An uplink media |
| | | | streaming request received at reference |
| | | | point M4u is mapped by the 5GMSu AS to |
| | | | a URL at reference point M2u whose base |
| | | | is the value of this property. |
| | | | In the case of push-based content egest |
| | | | (pull flag is set to False), this property is |
| | | | nominated by the 5GMSu Application |
| | | | Provider and indicates the base URL to |
| | | | which content for this Content Hosting |
| | | | Configuration is to be published. |
| cachingConfigurations | Array(Object) | 0 . . . 1 | Defines a configuration of the 5GMSu AS |
| | | | cache for a matching subset of media |
| | | | resources intended for egest in relation to |
| | | | this Content Publishing Configuration. |
| urlPatternFilter | String | 1 . . . 1 | A pattern that will be used to match media |
| | | | resource URLs to determine whether a |
| | | | given media resource is eligible for |
| | | | caching by the 5GMSu AS. The format of |
| | | | the pattern shall be a regular expression. |
| cachingDirectives | Object | 1 . . . 1 | If a urlPatternFilter applies to a resource, |
| | | | then the provided cachingDirectives shall |
| | | | be applied by the 5GMSu AS at M2u. |
| | | | These directives shall not overwrite any |
| | | | caching directives received at M4u. |
| statusCodeFilters | Array(Integer) | 0 . . . 1 | The set of HTTP origin response status |
| | | | codes to which these cachingDirectives |
| | | | apply. The filter shall be provided as a |
| | | | regular expression. |
| | | | If the list is empty, the CachingDirectives |
| | | | shall apply to all HTTP origin response |
| | | | status codes at M2u. |
| noCache | Boolean | 1 . . . 1 | If set to True, this indicates that the media |
| | | | resources matching the filters shall not be |
| | | | cached by the 5GMSu AS and shall be |
| | | | marked as not to be cached when served by |
| | | | the 5GMSu AS. |
| maxAge | Integer | 0 . . . 1 | The caching time-to-live period that shall |
| | | | be set on media resources matching the |
| | | | filters. This determines the minimum |
| | | | period for which the 5GMSu AS shall |
| | | | cache matching media resources as well as |
| | | | the time-to-live period signalled by the |
| | | | 5GMSu AS at interface M2u when it |
| | | | serves such media resources. |
| | | | The time-to-live for a given media |
| | | | resource shall be calculated relative to the |
| | | | time it was ingested. |

Table 4 below provides example protocols that may be specified in a configuration.

TABLE 4

| | | |
|---|---|---|
| Description | Term identifier | Clause |

Content ingest protocols at reference point M2d

| | | |
|---|---|---|
| HTTP pull-based content | urn:3gpp:5gms:content-protocol:http-pull or | 8.2 |
| ingest protocol | urn:3gpp:5gms:content-protocol: http-pull- | |
| | ingest (see NOTE) | |
| DASH-IF push-based content | http://dashif.org/ingest/v1.2/interface-1 or | 8.3 |
| ingest protocol | http://dashif.org/ingest/v1.2/interface-2 or | |
| | urn:3gpp:5gms:content-protocol:dash-if-ingest | |
| | (see NOTE) | |
| HTTP low-latency pull-based | urn:3gpp:5gms:content-protocol:http-ll-pull | 8.4 |
| content ingest protocol | | |

Content egest protocols at reference point M2u

| | | |
|---|---|---|
| HTTP pull-based content egest | urn:3gpp:5gms:content-protocol: http-pull | 8.5 |
| protocol | | |
| DASH-IF push-based content | http://dashif.org/ingest/v1.2/interface-1 or | 8.6 |
| egest protocol | http://dashif.org/ingest/v1.2/interface-2 | |
| HTTP low-latency pull-based | urn:3gpp:5gms:content-protocol: http-ll-pull | 8.7 |
| content egest protocol | | |

NOTE:
Term identifier deprecated in this version of the present document.

As is shown above, the 5GMS Application Provider defines in the content publishing provisioning whether a caching is required at 5GMS AS for the content that is expected to be egested by the 5GMS Application Provider. The rules of the content caching, the caching directives, the status codes and whether the content is cached, and if so, for how long is defined in the above resource.

The embodiments include content caching. A Content Hosting Configuration may specify caching rules to be applied to media resources when they are received by the 5GMSu AS over interface M4u or to the content preparation processing outputs if exist. In this case, a received media object over the interface M4u has a caching directive, that caching directive overwrites any other directive and is carried to the corresponding content preparation output(s). Otherwise, the urlPatternFilter shall be used in the CachingConfiguration to determine which caching directives apply. In case a media resource's URL matches the pattern filter of more than one CachingConfiguration, the first match shall apply. In the case where no match is found and no caching directive is provided at M4u, then default caching directives based on the media resource type shall be applied.

A caching directive shall either indicate that a matching media resource is not to be cached by the 5GMSu AS (noCache set to True), or that the 5GMSu is to cache it for maxAge seconds. The maxAge value applies relative to the time when a media resource was completely received by the 5GMSu AS at interface M4u, t_uplink. For an HTTP-based uplink streaming, this corresponds to the Date header field in the HTTP request/response that carries the media resource at M4u. At the time t_uplink+maxAge, the object and its corresponding content preparation output objects are considered stale and should not be served at M2u from the 5GMSu AS cache. The 5GMSu AS 305 shall compensate for any synchronization skew between the client and its own clock. This can be for instance done by including the max-stale HTTP cache directive in its M2u responses.

The maxAge value may be signaled at M2u by the 5GMSu AS 305 using the Expires HTTP response header or the HTTP Cache-Control directives max-age or s-maxage. When distributing a media resource using HTTP, a no-cache request may be translated into a no-cache and no-store HTTP Cache-Control directive and/or a max-age-0 HTTP Cache-Control directive. By default, all origin HTTP header fields from the client shall be assumed as not forwarded by the 5GMSu AS, unless specified otherwise by setting the flag originCacheHeaders to True. Embodiments include Cache purging.

The 5GMSu Application Provider 301 may perform a purge operation to invalidate some or all cached media resources of a particular Content Publishing Configuration. A regular expression describing the set of media resource URLs to be purged from the 5GMSu AS cache for the Content Publishing Configuration in question shall be supplied in the body of the request. The body shall be encoded using the application/x-www-form-urlencoded MIME content type as a key-value pair, with the key being the string pattern and the value is the regular expression.

On receiving a purge request, the 5GMSu AF 306 shall immediately invalidate all media resources in the 5GMSu AS cache matching the regular expression by declaring them as stale. In case of a Pull-based egest, any request at interface M2u for a purged media resource shall be responded to with a 404 (Not Found) HTTP response. In the case of Push-based egest, any purged media object shall not be pushed until a new version of that object becomes available.

If the procedure is successful, the 5GMSu AF 306 shall respond with one of the following response messages: (i) 204 (No Content) if no cache entries were purged, for example because no current cache entries matched the regular expression supplied in the original request; and (ii) 200 (OK) if some cache entries were purged. The body of the response message shall indicate the total number of cache entries purged in all 5GMSu AS instances distributing the Provisioning Session in question.

If the procedure is not successful, the 5GMSu AF shall provide a response code. In addition, the HTTP response 422 (Unprocessable Entity) shall be returned in the case where the request message body—or the regular expression contained in it—are found by the 5GMSd AF 306 to be syntactically malformed.

According to one or more embodiments, a method comprising content caching at 5G networks, wherein the content is cached by the 5GMS Application Server, for the purpose of the 5G Application Provider's egest, wherein the 5G Application Provider defines the caching rules during the content publishing provisioning, wherein the pattern of the content that the caching is required, the caching directives, the status codes, the duration of caching or no caching is defined, where the 5GMS AF uses the information to set up the 5GMS AS's output cache, wherein the rules of caching is applied to the uplink streaming content or the corresponding output of the content preparation processing, wherein the uplinked content has its own caching rules, those rules overwrite the caching rules defined by the 5G Application Provider.

While 3GPP TS26.501 defines the general uplink process, it does not define a background data transfer for the uplink streaming. The background data transfer uses the time intervals that are announced by the network to transfer the data in the network. In the case of uplink streaming, the captured content is transferred after the capture time in the suitable time interval(s) so that the network can more easily accommodate the bandwidth

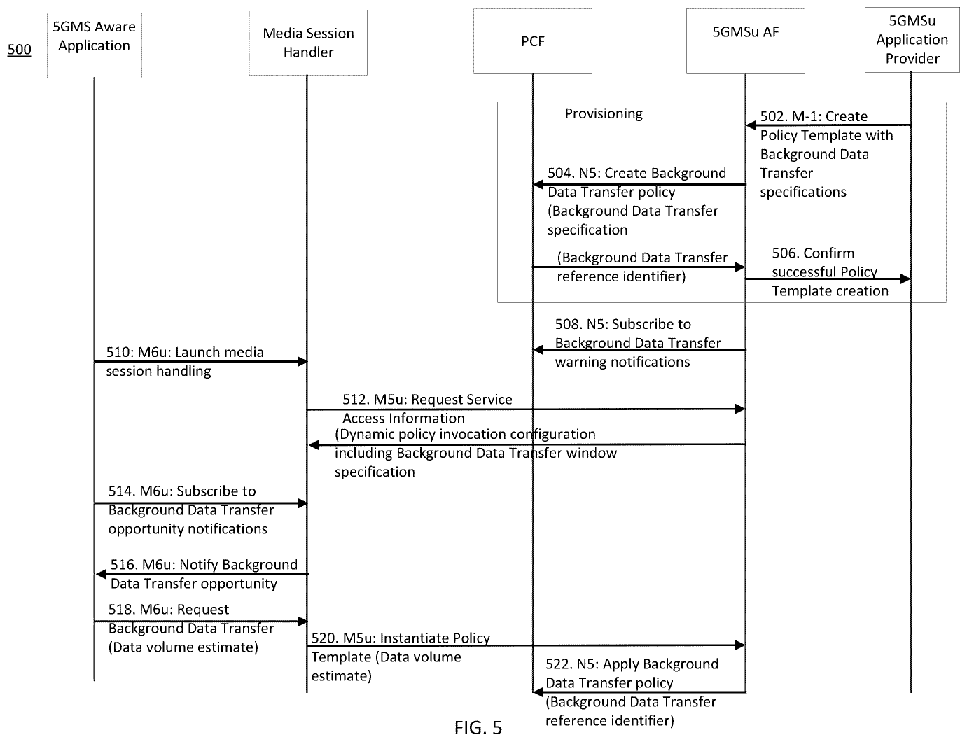

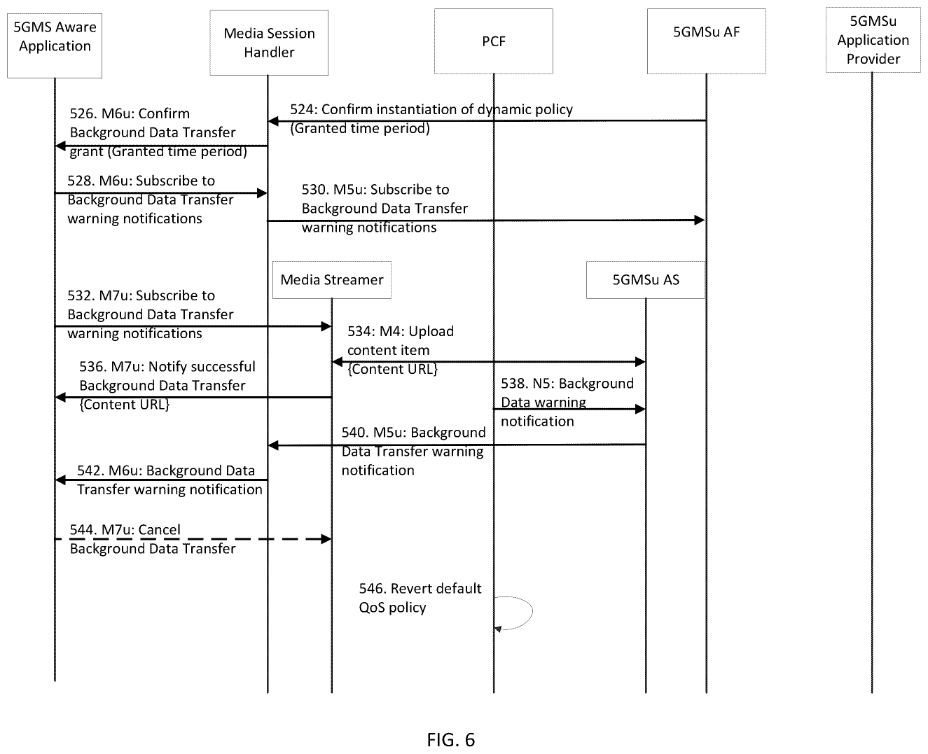

FIGS. 5 and 6 illustrate an example call flow 500 for the configuration and usage of a Background Data Transfer session in uplink 5G Media Streaming.

In one or more example, the call flow 500 may be performed in accordance with one or more of the following configurations. The 5GMSu Application Provider has negotiated a Service Level Agreement with the 5GMS System operator that includes all or some of the following: (i) time window(s) when Background Data Transfers are likely to be available. These may recur on a regular pattern (e.g., daily, weekly, monthly, etc.); (ii) a quota for the maximum number of 5GMS Clients that may avail themselves of a Background Data Transfer during each such time window; (iii) a quota for the maximum aggregate volume of data that may be transferred by all 5GMS Clients during each Background Data Transfer window; and (iv) network QoS parameters for each such Background Data Transfer, to be provisioned as part of Policy Templates. The 5GMS System operator may have provisioned a Background Data Transfer Policy in the PCF based on the Service Level Agreement, in which case it may share the corresponding Background Data Transfer reference identifier with the 5GMSu Application Provider.

The call flow 500 may implement the following operations.

Operation 502: The 5GMSu Application Provider provisions a Policy Template in the 5GMSu AF at reference point M1 that either references an existing Background Data Transfer policy already provisioned in the PCF that embodies the aforementioned Service Level Agreement or else directly specifies Background Data Transfer parameters in line with the aforementioned Service Level Agreement.

Operation 504: If the supplied Policy Template explicitly declares new Background Data Transfer parameters, the 5GMSu AF creates a corresponding new Background Data Transfer policy in the PCF based on them. The PCF may interact with the UDR as a consequence, yielding a Background Data Transfer reference identifier.

Operation 506: The 5GMSu AF acknowledges the successful creation of the Policy Template for the 5GMSu Application Provider. This confirms that the parameters of the Policy Template (including the Background Data Transfer parameters) are acceptable to the 5GMS System.

Operation 508: If it has not already done so, the 5GMSu AF subscribes to receive Background Data Transfer warning notifications from the PCF.

After operation 508, the following operations may be performed at a later point in time.

Operation 510: The 5GMSu-Aware Application launches media session handling using an appropriate service launch mechanism at reference point M6u.

Operation 512: In response, the Media Session Handler fetches Service Access Information from the 5GMS AF for the relevant Provisioning Session via reference point M5u. A client dynamic policy invocation configuration is provided that describes the Policy Templates applicable to the requesting 5GMS Client, including information about Background Data Transfer windows and endpoint(s) that the Media Session Handler may subscribe to receive Background Data Transfer warning notifications from the 5GMSu AF.

Operation 514: The 5GMSu-Aware Application also subscribes to receive notifications of Background Data Transfer opportunities from the Media Session Handler by invoking a client API on the latter at reference point M6d.

At the start of the next Background Data Transfer window, the following operations may be performed.

Operation 516: The Media Session Handler notifies its 5GMS-Aware Application subscriber(s) (see operation 514) of the Background Data Transfer opportunity by sending a notification to each one via reference point M6u.

Operation 518: A 5GMS-Aware Application that has received such a notification invokes a suitable client API on the Media Session Handler at reference point Mou to avail itself of the Background Data Transfer opportunity. The invocation includes an estimate of the data volume the 5GMS Client intends to transfer in the background.

Operation 520: The Media Session Handler instantiates a dynamic policy resource on the 5GMSu AF based on one of the Policy Templates advertised in the Service Access Information that includes Background Data Transfer parameters. The request includes an estimate of the data volume the 5GMS Client intends to transfer in the background.

Operation 522: If the request falls within a time window for Background Data Transfers advertised in the Service Access Information and if the quota for the number of Background Data Transfers within the current time window has not been exceeded, the Media Session Handler requests a change to the network QoS of the appropriate PDU Session by invoking the Npcf_PolicyAuthorization_Create operation (either directly or via the NEF) based on the Background Data Transfer parameters described in the appropriate Policy Template and citing the reference identifier of the Background Data Transfer referenced in operation 502 or created in operation 504.

Operation 524: The 5GMSu AF responds to the Media Session Handler to grant the Background Data Transfer request. The grant response includes a recommendation from the 5GMS AF of the maximum period for which the Background Data Transfer is available and the maximum Background Data Transfer volume granted for the media streaming session during this grant period (which may be smaller than that requested in operation 520).

Operation 526: Media Session Handler informs the 5GMSu-Aware Application of the Background Data Transfer grant by sending a notification to the latter at reference point M7u. The notification includes the maximum period recommendation and maximum data volume indicated by the 5GMSu AF in the previous operation.

Operation 528: The 5GMS-Aware Application subscribes to receive Background Data Transfer warning notifications from the Media Session Handler by invoking a client API on the latter at reference point M6u.

Operation 530: As a consequence, the Media Session Handler subscribes to receive Background Data Transfer warning notifications from the 5GMSu AF by invoking a network API on the latter at reference point M5u. The subscription endpoint(s) are indicated in the Service Access Information obtained in operation 512.

The following operations are repeated for each content item the 5GMSu-Aware Application would like to upload during the granted period for Background Data Transfers:

Operation 532: The 5GMS-Aware Application initiates the upload of a content item in the background by invoking a suitable client API on the Media Streamer at reference point M7. The destination of the content pm 5GMS AS is identified by a URL.

Operation 534: The Media Streamer uploads the content item to the 5GMSu AS at reference point M4d using the URL supplied in the previous operation.

Operation 536: The Media Streamer confirms that the content item has been successfully uploaded by sending a notification to the 5GMSu-Aware Application at reference point M7.

At any time during the Background Data Transfer window, the following may occur:

Operation 538: The PCF sends a Background Data Transfer warning notification to the 5GMS AF indicating that the network cannot satisfy the requirements of the Background Data Transfer policy at the UE's current location or that the volume of data transferred by all 5GMS Client in the current Background Data Transfer window has reached the quota provisioned in the Background Data Transfer policy.

Operation 540: The 5GMS AF notifies the Media Session Handler that the Background Data Transfer window has ended prematurely using an asynchronous notification mechanism at reference point M5u.

Operation 542: The Media Session Handler notifies the 5GMS-Aware Application that the Background Data Transfer window has ended prematurely using an asynchronous notification mechanism at reference point M6u.

Operation 544: The 5GMS-Aware Application may choose to cancel the Background Data Transfer by invoking a suitable client API method on the Media Streamer at reference point M7u.

In one or more examples, the 5GMS-Aware Application may decide to keep the state of the uplink streaming and continue the uplink streaming when the next Background Data Transfer window becomes available from the point it canceled the Background Data Transfer previously.

When the granted period for Background Data Transfers subsequently expires:

Operation 546: The PCF automatically reverts the network QoS of the media streaming session to its state before the Background Data Transfer grant without intervention from the 5GMS System.

According to one or more embodiments, a method for background data transfer of uplink streaming wherein the application service provider creates a policy template defining the background data transfer and this information is given to the user equipment (UE), wherein the UE also can subscribe to a service to receive the background data transfer opportunities, wherein the application of UE during the allowed time interval provides a URL in network to the media streamer to upload the content and continues doing so until either to complete the content or the network notifies the UE that the background data transfer is not possible anymore.

While 3GPP TS26.501 defines the general uplink process, it does not define how to use the dynamic policies for improving the uplink streaming. The dynamic policy API allows the assignment of more than one network slice. However the use of this feature of uplink streaming has not been shown in 3GPP TS26.501.

In one or more examples, the 5GMSu Application Provider requests the assignment of more than one network slice for the uplink streaming service. The 5GMSu Application Provider indicates the desired network slice features that correspond to the Service Access Information. Upon successful assignment of the network slices for the service, the 5GMSu AF shall respond with the list of allowed S-NSSAIs to the 5GMSu Application Provider.

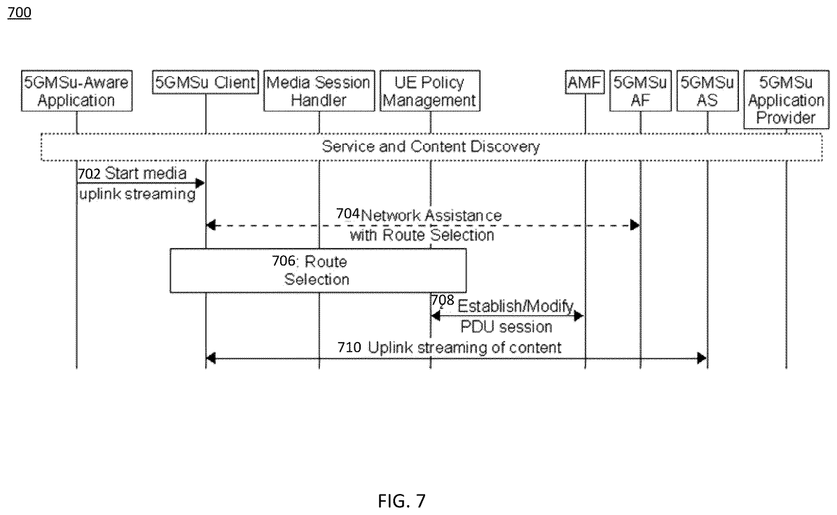

FIG. 7 illustrates an example call flow 700 for dynamic policy based on network slicing for uplink streaming. The call flow 700 may be performed based on one or more of the following configurations. First, the UE knows how to access the network slice(s) associated with a particular Provisioning Session. Second, the 5GMSu aS(s) serving the content for the particular Provisioning Session shall be accessible through the DNN(s) associated to the network slice(s) provisioned for the distribution of that content.

The call flow 700 may include the following operations.

Operation 702: The 5GMSu-Aware Application triggers the 5GMSu Client for uplink streaming of the selected content.

Operation 704: The 5GMSu Client retrieves information from the 5GMSu AF to assist with the route selection for the session. This may include information about the network slices, the DNNs, any pre-authorized QoS guarantees for that Provisioning Session.

Operation 706: The 5GMSu Client and the UE Policy Management in the UE perform the route selection procedure using information such as the uplink streaming operation point and the traffic descriptors. The UE Policy Management will use the matching filter to retrieve the Route Selection descriptor, which provides the DNN, and the S-NSSAI(s), identifying the network slice(s) to be used for this Provisioning Session.

Operation 708: The UE reuses an existing PDU session with the selected S-NSSAI and DNN from operation 706, or requests the establishment of a new PDU session with the identified parameters, if one doesn't exist already.

Operation 710: The upstreaming of the media content at the target operation point starts.

Based on the call flow 700, the 5GMS client can perform route selection for the uplink streaming session.

According to one or more embodiments, a method of setting up the uplink streaming session by a device in 5G network is performed, where the dynamic policies are invoked to use more than one network slice for uplink streaming.

The 5G augmented reality devices need to have intensive processing, including multiple parallel media decoding and possibility media encoding, scene composition, and augmented reality rendering. When the Application and/or Application Service Provider decides to run the client media functions in the split-rendering fashion, they have to replace this functionality with two new modules: 1. The edge-dependent light media service client, and 2. The media processing application running on 5GMS AS.

The current specification defines split rendering configuration parameters, including the desired view information. The device is expected to send back the view position information for those views to the network. However, the configuration parameters do not define any specification of how often and with what increments those position information needs to be captured and sent to the network.

The embodiments of the present disclosure are directed to defining a new set of parameters for efficient view position information reporting for split-rendering applications running over 5G networks.

The embodiments include parameters for the frequency and threshold of position information reporting. In one or more examples, three parameters are defined for the frequency and threshold of position information reporting.

In one or more examples a maximum frequency (MF) of position information is defined to be the maximum number of position instances in the second to be reported. This value defines an upper bound for the maximum number of position reporting for the device.

In one or more examples, a minimum interval (MI) is defined for position information to be the minimum time interval for the two position-reporting instances from the client to the network. This value may be defined in milliseconds.

In one or more examples, a minimum change threshold (MT) for position reporting is defined as the minimum value change for the position information change to be reported by the device to the network. If the position change is less than this value, it won't be reported. This value may be defined for each axis X, Y, and Z separately.

According to one or more embodiments, the network announces these parameters as part of the split-rendering configuration to the device. These sets of parameters may be defined for each view. The XR runtime captures the position information and provides it to the XR Source Manager. The XR source manager may use the above parameters in the following manner: (1) When the position information change is less than the minimum threshold (MT) in all axes, it won't report the change to the network; (2) Otherwise, it measures the time interval before the last time reporting of this position parameter till now. If it is smaller than the minimum interval (MI) or 1/maximum frequency (MF), then it won't report the change to the network; and (3) Otherwise, it reports the change in the network. The benefit of the above approach is that it limits the number of time reporting to the network, therefore it reduces the traffic and the bandwidth, and the network does not need to process the extra data.

The criteria for the edge application to set these parameters may be application-dependent. Depending on the needs of the application, the sensitivity of the application to the post information, both in terms of frequency as well as level sensitivity, defines the values of these parameters.

The above parameters may be added to the split rendering configuration format as specified in Table 5.

TABLE 5

| Name | Type | Cardinality | Description |
|---|---|---|---|
| renderingFlags | Array(SR_CONFIG_FLAGS) | 0 . . . 1 | Provides a set of flags to |
| | | | activate/deactivate selected |
| | | | rendering functions. The defined |
| | | | SR_CONFIG_FLAGS are: |
| | | | • FLAG_ALPHA_BLENDING |
| | | | • FLAG_DEPTH_COMPOSITION |
| | | | • FLAG_EYE_GAZE_TRACKING |
| spaceConfiguration | Object | 0 . . . 1 | The space configuration is |
| | | | typically sent by the split |
| | | | rendering server to the split |
| | | | rendering client. Upon reception |
| | | | of this information, the SR client |
| | | | uses this information to create the |
| | | | reference and action spaces as well |
| | | | as to agree on common identifiers |
| | | | for the XR spaces. |
| referenceSpaces | Array | 0 . . . 1 | An array of reference spaces and |
| | | | their identifiers. |
| Id | Number | 1 . . . 1 | A unique identifier of the XR |
| | | | space in the context of the split |
| | | | rendering session. |
| refSpace | Enum | 1 . . . 1 | One of the defined reference |
| | | | spaces in OpenXR. These may be: |
| | | | XR_REFERENCE_SPACE_TYPE_VIEW, |
| | | | XR_REFERENCE_SPACE_TYPE_LOCAL, or |
| | | | XR_REFERENCE_SPACE_TYPE_STAGE. |
| actionSpaces | Array | 0 . . . 1 | An array of action spaces that need |
| | | | to be defined by the split rendering |
| | | | client in the XR session. |
| Id | Number | 1 . . . 1 | A unique identifier of the XR |
| | | | space in the context of the split |
| | | | rendering session. |
| actionId | Number | 1 . . . 1 | Provides the unique identifier of |
| | | | the action. |
| subactionPath | String | 1 . . . 1 | The subaction path identifies the |
| | | | action, which can then be mapped |
| | | | by the XR runtime to user input |
| | | | modalities. |
| initialPose | Pose | 0 . . . 1 | Provides the initial pose of the new |
| | | | XR space's origin. |
| viewConfiguration | Object | 0 . . . 1 | Conveys the view configuration |
| | | | that is configured for the XR |
| | | | session. |
| Type | Enum | 1 . . . 1 | The type indicates the view |
| | | | configuration. Defined values are |
| | | | MONO and STEREO. Other |
| | | | values may be added. |
| Width | Number | 1 . . . 1 | The recommended width of the |
| | | | swapchain image. |
| Height | Number | 1 . . . 1 | The recommended height of the |
| | | | swapchain image. |
| compositionLayer | String | 1 . . . 1 | An identifier of the selected |
| | | | composition layer. |
| poseReporting | Array (object) | 0 . . . 1 | |
| maxPoseFreq | Number | 0 . . . 1 | The maximum frequency of |
| | | | reporting pose information per |
| | | | second. |
| minPoseIntvl | Float | 0 . . . 1 | The minimum time interval |
| | | | between two pose reporting in |
| | | | milliseconds. |
| | | | This value shall not be present if |
| | | | maxPoseFreq is present and vice |
| | | | versa. |
| minPoseDeltaX | Object | 01 | The minimum x threshold for the |
| | | | pose change for reporting it. |
| minPoseDeltaY | Object | 01 | The minimum y threshold for the |
| | | | pose change for reporting it. |
| minPoseDeltaZ | Object | 01 | The minimum z threshold for the |
| | | | pose change for reporting it. |
| environmentBlendMode | Enum | 1 . . . 1 | The type indicates the |
| | | | environment blend mode |
| | | | configuration. Defined values are |
| | | | OPAQUE, ADDITIVE, and |
| | | | ALPHA_BLEND. Other values |
| | | | may be added. |
| actionConfiguration | Array | 0 . . . 1 | This contains a list of the actions |
| | | | that are to be defined by the SR |
| | | | client. |
| Action | Object | 1 . . . n | A definition of a single action |
| | | | object. |
| Id | Number | 1 . . . 1 | A unique identifier of the action. |
| actionType | Enum | 1 . . . 1 | The type of the action state. This |
| | | | can be a Boolean, float, vector2, |
| | | | pose, vibration output, etc. |
| subactionPaths | String | 1 . . . n | An array of subaction paths |
| | | | associated with this action. The |
| | | | split rendering client will provide |
| | | | the state of all defined sub-action |
| | | | paths. |
| extraConfigurations | Object | 0 . . . 1 | A placeholder for additional |
| | | | configuration information. |

The new parameters in Table 5 are underlined.

According to one or more embodiments, a procedure of setting the maximum frequency/minimum interval and the minimum charge level of the position information for devices to report to the network that is used in a split-rendering fashion in 5G networks wherein these values define how often and what the minimum level of change a device should report the position information change, wherein these parameters are set by the split-rendering application running on the edge server/network and depending the sensitivity and speed of the application, these values are set and communicated as part of the split-rendering configuration to the device.

The techniques described above may be implemented as computer software using computer-readable instructions and physically stored in one or more computer-readable media.

Embodiments of the present disclosure may be used separately or combined in any order. Further, each of the embodiments (and methods thereof) may be implemented by processing circuitry (e.g., one or more processors or one or more integrated circuits). In one example, the one or more processors execute a program that is stored in a non-transitory computer-readable medium.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

Even though combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A method performed by at least one processor, the method comprising:
provisioning, between a 5^{th} generation media streaming (5GMS) application provider and a 5GMS application function (5GMS AF), a content publishing configuration for uplink streaming in a 5GMS network,
wherein the content publishing configuration comprises a media entry point associated with a 5GMS application server (AS) for uplink streaming,
wherein the content publishing configuration comprises a publishing configuration parameter that specifies one or more protocols for the uplink streaming between a 5GMS client and the 5GMS AS, and
wherein the content publishing configuration comprises a content preparation parameter that indicates a content preparation process performed by the 5GMS AS for egest of the content received from the 5GMS client to the 5GMS application provider.

2. The method according to claim 1, wherein the content preparation parameter specifies a content preparation template ID that identifies a content preparation template for the content preparation process.

3. The method according to claim 1, wherein the publishing configuration parameter further specifies a server associated with the 5GMS application provider that receives content streamed to the 5GMS AS.

4. The method according to claim 1, wherein the publishing configuration parameter further specifies whether one of (i) a pull based content egest is used for egesting content from the 5GMS AS to the 5GMS application provider and (ii) a push based content egest is used for egesting content from the 5GMS AS to the 5GMS application provider.

5. The method according to claim 1, wherein the 5GMS client selects one protocol from the one or more protocols for the uplink protocol.

6. The method according to claim 1, wherein the 5GMS application provider is configured to transmit a command to the 5GMS AF to update the content publishing configuration.

7. The method according to claim 1, wherein the content publishing configuration includes one or more dynamic policies,
wherein the 5GMS client invokes one of the one or more dynamic policies to set up the uplink streaming on a network slice.

8. The method according to claim 1, wherein the content publishing configuration comprises a cache parameter that defines a cache at the 5GMS AS for caching the content streamed from the 5GMS client to the 5GMS AS.

9. The method according to claim 8, wherein the cache parameter comprises a filter parameter that specifies a pattern, wherein the content from the 5GMS client that matches the pattern is stored in the cache.

10. The method according to claim 9, wherein the cache parameter comprises a no-cache parameter that indicates that the content from the 5GMS client that matches the pattern is not stored in the cache.

11. The method according to claim 8, wherein the cache parameter comprises one or more caching directives applied to an interface between the 5GMS application provider and the 5GMS AS.

12. The method according to claim 8, wherein the cache parameter comprises a duration parameter that specifies a minimum period in which content is stored in the cache.

13. A method performed by at least one processor, the method comprising:
provisioning, by a 5^{th} generation media streaming (5GMS) a policy template associated with a background data transfer policy for uplink streaming in a 5GMS network,
wherein the background data transfer policy comprises a background data transfer window, and
wherein the background data transfer policy is provided to a user equipment.

14. The method according to claim 1, wherein the UE subscribes to a service to receive one or more background data transfer opportunities regarding the background data transfer window.

15. The method according to claim 12, wherein the background data transfer policy is an existing policy provisioned in a policy control function (PCF).

16. The method according to claim 12, wherein the background data transfer policy is created by a 5GMS application function (AF) based on a new policy declaration in the policy template.

17. A method performed by at least one processor, the method comprising:
provisioning a split-rendering configuration in a 5^{th} generation (5G) network that specifies position information for one or more user equipment (UEs) to report to the network,
wherein the position parameters specify at least a frequency for reporting and an interval for reporting the position information, and
wherein the position parameters are reported to the one or more UEs as part of the split-rendering configuration.

18. The method according to claim 17, wherein the position parameters specify a maximum frequency of reporting the position information per second.

19. The method according to claim 17, wherein the position parameters specify a minimum time interval between reporting the position information.

20. The method according to claim 17, wherein the position information specifies one of (i) a first minimum threshold that specifies a minimum position change along a first axis for reporting the position information, (ii) a second minimum threshold that specifies a minimum position change along a second axis perpendicular to the first axis for reporting the position information, and (iii) a third minimum threshold that specifies a minimum position change along a third axis perpendicular to the second axis and the first axis for reporting the position information.
